(19) United States
(12) Patent Application Publication
(10) Pub. No.: US 2025/0393054 A1
(43) Pub. Date: Dec. 25, 2025

(54) TECHNIQUES FOR ADJUSTING A QUANTITY OF MONITORED CONTROL CANDIDATES OR CONTROL RESOURCES

(71) Applicant: QUALCOMM Incorporated, San Diego, CA (US)

(72) Inventors: Gabi SARKIS, San Diego, CA (US); Weimin DUAN, San Diego, CA (US); Kangqi LIU, San Diego, CA (US); Le LIU, San Jose, CA (US); Diana MAAMARI, San Diego, CA (US); Jing JIANG, San Diego, CA (US); Tingfang JI, San Diego, CA (US)

(21) Appl. No.: 18/749,418

(22) Filed: Jun. 20, 2024

(51) Int. Cl. H04W 72/231; H04W 72/02; H04W 72/12

(52) U.S. Cl. CPC H04W 72/231; H04W 72/02; H04W 72/12

(57) ABSTRACT

Methods, systems, and devices for wireless communications are described. Techniques described herein provide for adjusting a quantity of monitored control channel candidates or control resources. In some examples, a user equipment (UE) may receive, from a network entity, first control signaling indicating a control channel search space configuration. The control channel search space configuration may include a plurality of monitored control candidates or control resources of a control channel. The UE may monitor a first subset of the plurality of monitored control candidates or control resources for a control channel message. The first subset of the plurality of monitored control candidates or control resources may include a first quantity of the plurality of monitored control candidates or control resources, and the first quantity may be based on a processing time associated with the UE, a minimum scheduling offset associated with the UE, or both.

### FIELD OF TECHNOLOGY

The following relates to wireless communications, including techniques for adjusting a quantity of monitored control candidates or control resources.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by a user equipment (UE) is described. The method may include receiving, from a network entity, first control signaling indicating a control channel search space configuration, where the control channel search space configuration includes a set of multiple monitored control candidates or control resources of a control channel and monitoring a first subset of the set of multiple monitored control candidates or control resources for a control channel message, where the first subset of the set of multiple monitored control candidates or control resources includes a first quantity of the set of multiple monitored control candidates or control resources, and where the first quantity is based on a processing time associated with the UE, a minimum scheduling offset associated with the UE, or both.

A UE for wireless communication is described. The UE may include one or more memories storing processor executable code, and one or more processors coupled with the one or more memories. The one or more processors may individually or collectively be operable to execute the code to cause the UE to receive, from a network entity, first control signaling indicating a control channel search space configuration, where the control channel search space configuration includes a set of multiple monitored control candidates or control resources of a control channel and monitor a first subset of the set of multiple monitored control candidates or control resources for a control channel message, where the first subset of the set of multiple monitored control candidates or control resources includes a first quantity of the set of multiple monitored control candidates or control resources, and where the first quantity is based on a processing time associated with the UE, a minimum scheduling offset associated with the UE, or both.

Another UE for wireless communication is described. The UE may include means for receiving, from a network entity, first control signaling indicating a control channel search space configuration, where the control channel search space configuration includes a set of multiple monitored control candidates or control resources of a control channel and means for monitoring a first subset of the set of multiple monitored control candidates or control resources for a control channel message, where the first subset of the set of multiple monitored control candidates or control resources includes a first quantity of the set of multiple monitored control candidates or control resources, and where the first quantity is based on a processing time associated with the UE, a minimum scheduling offset associated with the UE, or both.

A non-transitory computer-readable medium storing code for wireless communication is described. The code may include instructions executable by one or more processors to receive, from a network entity, first control signaling indicating a control channel search space configuration, where the control channel search space configuration includes a set of multiple monitored control candidates or control resources of a control channel and monitor a first subset of the set of multiple monitored control candidates or control resources for a control channel message, where the first subset of the set of multiple monitored control candidates or control resources includes a first quantity of the set of multiple monitored control candidates or control resources, and where the first quantity is based on a processing time associated with the UE, a minimum scheduling offset associated with the UE, or both.

In some examples of the method, user equipment (UEs), and non-transitory computer-readable medium described herein, the first quantity may be based on a control channel monitoring periodicity.

Some examples of the method, user equipment (UEs), and non-transitory computer-readable medium described herein may further include operations, features, means, or instructions for monitoring a second subset of the set of multiple monitored control candidates or control resources, where the second subset of the set of multiple monitored control candidates or control resources includes a second quantity of the set of multiple monitored control candidates or control resources that may be based on a change in the processing time, a change in the minimum scheduling offset, a change in a control channel monitoring periodicity, or any combination thereof.

In some examples of the method, user equipment (UEs), and non-transitory computer-readable medium described herein, the second quantity may be greater than or less than the first quantity.

In some examples of the method, user equipment (UEs), and non-transitory computer-readable medium described herein, monitoring the second subset may include operations, features, means, or instructions for selecting the second subset from a set of multiple subsets of the set of multiple monitored control candidates or control resources, where the control channel search space configuration includes the set of multiple subsets, and where each of the set of multiple subsets include a different quantity of the set of multiple monitored control candidates or control resources.

Some examples of the method, user equipment (UEs), and non-transitory computer-readable medium described herein may further include operations, features, means, or instructions for applying a hashing function to the set of multiple monitored control candidates or control resources to identify the second subset of the set of multiple monitored control candidates or control resources.

Some examples of the method, user equipment (UEs), and non-transitory computer-readable medium described herein may further include operations, features, means, or instructions for receiving, from the network entity subsequent to monitoring the first subset of the set of multiple monitored control candidates or control resources, second control signaling that indicates a second quantity of the set of multiple monitored control candidates or control resources and monitoring a second subset of the set of multiple monitored control candidates or control resources, where the second subset of the set of multiple monitored control candidates or control resources includes a second quantity of the set of multiple monitored control candidates or control resources.

Some examples of the method, user equipment (UEs), and non-transitory computer-readable medium described herein may further include operations, features, means, or instructions for transmitting, to the network entity subsequent to receiving the first control signaling, second control signaling that indicates the first quantity.

In some examples of the method, user equipment (UEs), and non-transitory computer-readable medium described herein, the second control signaling that indicates the first quantity includes a quantity of monitored control candidates, a limit associated with a ratio of the quantity of monitored control candidates to the minimum scheduling offset, a limit associated with a ratio of the quantity of monitored control candidates to a control channel monitoring periodicity, a limit associated with a ratio of the quantity of monitored control candidates to the processing time, or any combination thereof.

In some examples of the method, user equipment (UEs), and non-transitory computer-readable medium described herein, the first quantity may be based on the processing time associated with an uplink grant, the minimum scheduling offset associated with the uplink grant, or both.

In some examples of the method, user equipment (UEs), and non-transitory computer-readable medium described herein, the first quantity may be based on the processing time associated with a downlink grant, the minimum scheduling offset associated with the downlink grant, or both.

In some examples of the method, user equipment (UEs), and non-transitory computer-readable medium described herein, the first quantity may be based on a downlink control information format.

A method for wireless communication by a network entity is described. The method may include outputting, to a UE, first control signaling indicating a control channel search space configuration, where the control channel search space configuration includes a set of multiple monitored control candidates or control resources of a control channel, selecting a first monitored control candidate or control resource from a first subset of the set of multiple monitored control candidates or control resources, where the first subset of the set of multiple monitored control candidates or control resources includes a first quantity of the set of multiple monitored control candidates or control resources, and where the first quantity is based on a processing time associated with the UE, a minimum scheduling offset associated with the UE, or both, and outputting, to the UE, one or more first control channel messages via the first monitored control candidate or control resource.

A network entity for wireless communication is described. The network entity may include one or more memories storing processor executable code, and one or more processors coupled with the one or more memories. The one or more processors may individually or collectively be operable to execute the code to cause the network entity to output, to a UE, first control signaling indicating a control channel search space configuration, where the control channel search space configuration includes a set of multiple monitored control candidates or control resources of a control channel, select a first monitored control candidate or control resource from a first subset of the set of multiple monitored control candidates or control resources, where the first subset of the set of multiple monitored control candidates or control resources includes a first quantity of the set of multiple monitored control candidates or control resources, and where the first quantity is based on a processing time associated with the UE, a minimum scheduling offset associated with the UE, or both, and output, to the UE, one or more first control channel messages via the first monitored control candidate or control resource.

Another network entity for wireless communication is described. The network entity may include means for outputting, to a UE, first control signaling indicating a control channel search space configuration, where the control channel search space configuration includes a set of multiple monitored control candidates or control resources of a control channel, means for selecting a first monitored control candidate or control resource from a first subset of the set of multiple monitored control candidates or control resources, where the first subset of the set of multiple monitored control candidates or control resources includes a first quantity of the set of multiple monitored control candidates or control resources, and where the first quantity is based on a processing time associated with the UE, a minimum scheduling offset associated with the UE, or both, and means for outputting, to the UE, one or more first control channel messages via the first monitored control candidate or control resource.

A non-transitory computer-readable medium storing code for wireless communication is described. The code may include instructions executable by one or more processors to output, to a UE, first control signaling indicating a control channel search space configuration, where the control channel search space configuration includes a set of multiple monitored control candidates or control resources of a control channel, select a first monitored control candidate or control resource from a first subset of the set of multiple monitored control candidates or control resources, where the first subset of the set of multiple monitored control candidates or control resources includes a first quantity of the set of multiple monitored control candidates or control resources, and where the first quantity is based on a processing time associated with the UE, a minimum scheduling offset associated with the UE, or both, and output, to the UE, one or more first control channel messages via the first monitored control candidate or control resource.

In some examples of the method, network entities, and non-transitory computer-readable medium described herein, the first quantity may be based on a control channel monitoring periodicity.

Some examples of the method, network entities, and non-transitory computer-readable medium described herein may further include operations, features, means, or instructions for outputting, to the UE, one or more second control channel messages via a second monitored control candidate or control resource selected from a second subset of the set of multiple monitored control candidates or control resources, where the second subset of the set of multiple monitored control candidates or control resources includes a second quantity of the set of multiple monitored control candidates or control resources that may be based on a change in the processing time, a change in the minimum scheduling offset, a change in a control channel monitoring periodicity, or any combination thereof.

In some examples of the method, network entities, and non-transitory computer-readable medium described herein, the second quantity may be greater than or less than the first quantity.

Some examples of the method, network entities, and non-transitory computer-readable medium described herein may further include operations, features, means, or instructions for applying a hashing function to the set of multiple monitored control candidates or control resources to identify the second subset of the set of multiple monitored control candidates or control resources.

Some examples of the method, network entities, and non-transitory computer-readable medium described herein may further include operations, features, means, or instructions for outputting, to the UE subsequent to the one or more first control channel messages, second control signaling that indicates a second quantity of the set of multiple monitored control candidates or control resources and outputting, to the UE, one or more second control channel messages via a second monitored control candidate or control resource selected from a second subset of the set of multiple monitored control candidates or control resources, where the second subset of the set of multiple monitored control candidates or control resources includes the second quantity of the set of multiple monitored control candidates or control resources.

Some examples of the method, network entities, and non-transitory computer-readable medium described herein may further include operations, features, means, or instructions for receiving, from the UE subsequent to the first control signaling, second control signaling that indicates the first quantity.

In some examples of the method, network entities, and non-transitory computer-readable medium described herein, the second control signaling that indicates the first quantity includes a quantity of monitored control candidates, a limit associated with a ratio of the quantity of monitored control candidates to the minimum scheduling offset, a limit associated with a ratio of the quantity of monitored control candidates to a control channel monitoring periodicity, a limit associated with a ratio of the quantity of monitored control candidates to the processing time, or any combination thereof.

In some examples of the method, network entities, and non-transitory computer-readable medium described herein, the first quantity may be based on the processing time associated with an uplink grant, the minimum scheduling offset associated with the uplink grant, or both.

In some examples of the method, network entities, and non-transitory computer-readable medium described herein, the first quantity may be based on the processing time associated with a downlink grant, the minimum scheduling offset associated with the downlink grant, or both.

In some examples of the method, network entities, and non-transitory computer-readable medium described herein, the first quantity may be based on a downlink control information format.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for adjusting a quantity of monitored control candidates or control resources in accordance with one or more aspects of the present disclosure.

FIG. 2 shows an example of a wireless communications system that supports techniques for adjusting a quantity of monitored control candidates or control resources in accordance with one or more aspects of the present disclosure.

FIG. 3 shows an example of a timing diagram that supports techniques for adjusting a quantity of monitored control candidates or control resources in accordance with one or more aspects of the present disclosure.

FIG. 4 shows an example of a process flow that supports techniques for adjusting a quantity of monitored control candidates or control resources in accordance with one or more aspects of the present disclosure.

FIGS. 5 and 6 show block diagrams of devices that support techniques for adjusting a quantity of monitored control candidates or control resources in accordance with one or more aspects of the present disclosure.

FIG. 7 shows a block diagram of a communications manager that supports techniques for adjusting a quantity of monitored control candidates or control resources in accordance with one or more aspects of the present disclosure.

FIG. 8 shows a diagram of a system including a device that supports techniques for adjusting a quantity of monitored control candidates or control resources in accordance with one or more aspects of the present disclosure.

FIGS. 9 and 10 show block diagrams of devices that support techniques for adjusting a quantity of monitored control candidates or control resources in accordance with one or more aspects of the present disclosure.

FIG. 11 shows a block diagram of a communications manager that supports techniques for adjusting a quantity of monitored control candidates or control resources in accordance with one or more aspects of the present disclosure.

FIG. 12 shows a diagram of a system including a device that supports techniques for adjusting a quantity of monitored control candidates or control resources in accordance with one or more aspects of the present disclosure.

FIGS. 13 through 15 show flowcharts illustrating methods that support techniques for adjusting a quantity of monitored control candidates or control resources in accordance with one or more aspects of the present disclosure.

### DETAILED DESCRIPTION

Some wireless communication systems may deploy a network entity and a user equipment (UE). The network entity may provide the UE with a control channel search space configuration that includes a quantity of physical downlink control channel (PDCCH) candidates. The UE may blind decode each of the configured PDCCH candidates regardless of whether the network entity has transmitted control channel messages in the PDCCH candidates. The UE blind decoding the configured PDCCH candidates not associated with transmitted control channel messages may be a waste of energy. However, reducing the quantity of monitored PDCCH candidate may negatively impact scheduling. In some cases, the UE may have a scheduling offset (K0) between the PDCCH candidate and a physical downlink shared channel resource, and the UE may have a scheduling offset (K2) between the PDCCH candidate and a physical uplink shared channel resource. Small duration scheduling offsets and a large quantity of monitored PDCCH candidates may be associated with significant power consumption and implementation complexity at the UE. As such, approaches for adjusting a quantity of monitored PDCCH candidates may be desirable.

Techniques for adjusting a quantity of monitored PDCCH candidates or a quantity of control resources may be employed. For example, a UE may receive, from a network entity, control signaling indicating a control channel search space configuration. The control channel search space configuration may include a plurality of monitored control candidates (e.g., monitored PDCCH candidates) or control resources (e.g., non-overlapping channel control elements (CCEs)) of a control channel. The UE may monitor a subset of the plurality of monitored control candidates or control resources for a control channel message. The subset of the plurality of monitored control candidates or control resources may include a first quantity of the plurality of monitored control candidates or control resources. The first quantity may be based on a processing time (e.g., a minimum processing time) associated with the UE, a scheduling offset associated with the UE (e.g., a minimum scheduling offset), or both. In some cases, the first quantity of the plurality of monitored control candidates or control resources may be based on a control channel monitoring periodicity. In some examples, when the processing time, the scheduling offset, or the control channel monitoring periodicity changes, the quantity of the plurality of monitored control candidates or control resources may be modified.

Aspects of the disclosure are initially described in the context of wireless communications systems. Aspects of the disclosure are also described in context of a timing diagram and a process flow. Aspects of the disclosure are further illustrated by and described with reference to apparatus diagrams, system diagrams, and flowcharts that relate to techniques for adjusting a quantity of monitored control candidates or control resources.

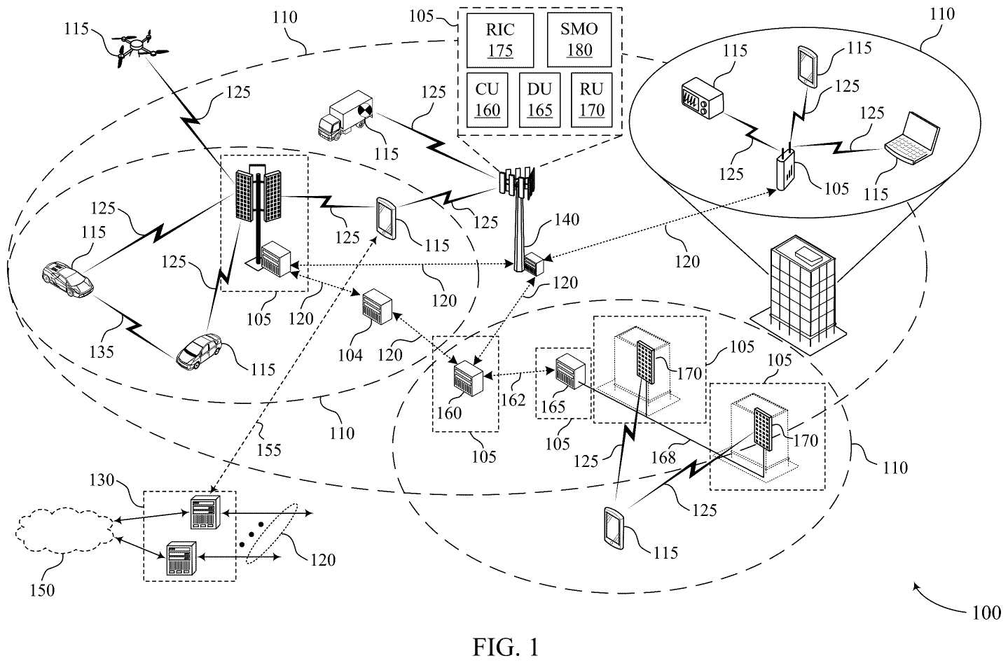

FIG. 1 shows an example of a wireless communications system 100 that supports techniques for adjusting a quantity of monitored control candidates or control resources in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. HARQ feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some wireless communication systems may deploy a network entity 105 and a UE 115. The network entity 105 may provide the UE 115 with a control channel search space configuration that includes a quantity of PDCCH candidates. The UE 115 may blind decode each of the configured PDCCH candidates regardless of whether the network entity 105 has transmitted control channel messages in the PDCCH candidates. The UE 115 blind decoding the configured PDCCH candidates not associated with transmitted control channel messages may be a waste of energy. However, reducing the quantity of monitored PDCCH candidate may negatively impact scheduling. In some cases, the UE 115 may have a scheduling offset (K0) between the PDCCH candidate and a physical downlink shared channel resource, and the UE may have a scheduling offset (K2) between the PDCCH candidate and a physical uplink shared channel resource. Small duration scheduling offsets and a large quantity of monitored PDCCH candidates may be associated with significant power consumption and implementation complexity at the UE 115. As such, approaches for adjusting a quantity of monitored PDCCH candidates may be desirable.

Techniques for adjusting a quantity of monitored PDCCH candidates or a quantity of control resources may be employed. For example, a UE 115 may receive, from a network entity 105, control signaling indicating a control channel search space configuration. The control channel search space configuration may include a plurality of monitored control candidates (e.g., monitored PDCCH candidates) or control resources (e.g., non-overlapping channel control elements (CCEs)) of a control channel. The UE 115 may monitor a subset of the plurality of monitored control candidates or control resources for a control channel message. The subset of the plurality of monitored control candidates or control resources may include a first quantity of the plurality of monitored control candidates or control resources. The first quantity may be based on a processing time (e.g., a minimum processing time) associated with the UE 115, a scheduling offset associated with the UE 115 (e.g., a minimum scheduling offset), or both. In some cases, the first quantity of the plurality of monitored control candidates or control resources may be based on a control channel monitoring periodicity. In some examples, when the processing time, the scheduling offset, or the control channel monitoring periodicity changes, the quantity of the plurality of monitored control candidates or control resources may be modified.

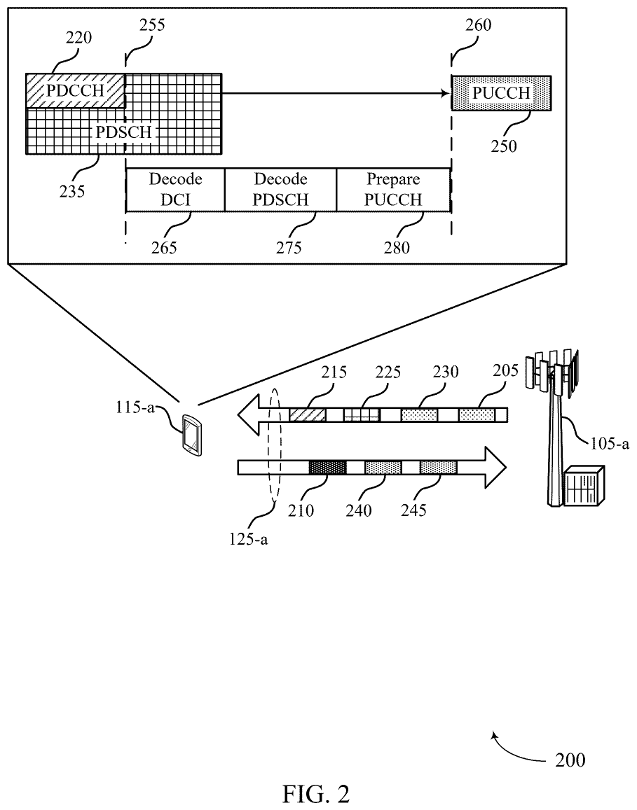

FIG. 2 shows an example of a wireless communications system 200 that supports techniques for adjusting a quantity of monitored control candidates or control resources in accordance with one or more aspects of the present disclosure. The wireless communications system 200 may implement aspects of or may be implemented by aspects of the wireless communications system 100. For example, the wireless communications system 200 includes a UE 115-a and a network entity 105-a, which may be examples of a UE 115 and a network entity 105 as described herein.

The UE 115-a may communicate with the network entity 105-a using a communication link 125-a. The communication link 125-a may be an example of a 6th generation (6G), a NR or LTE link between the UE 115-a and the network entity 105-a. The communication link 125-a may include bi-directional links that enable both uplink and downlink communications. For example, the network entity 105-a may transmit downlink signals (e.g., downlink transmission 205), such as downlink control signaling and downlink data signals, to the UE 115-a using the communication link 125-a, and the UE 115-a may transmit uplink signals (e.g., uplink transmission 210), including uplink control signaling and uplink data signals to the network entity 105-a using the communication link 125-a.

In some examples, the UE 115-a may receive control signaling 215 that indicates a control channel search space configuration. The control search space configuration may include a quantity of PDCCH candidates that the UE 115-a attempts to decode for each aggregation level. A PDCCH candidate 220 may start at a specific location (e.g., CCE). The PDCCH candidates for the same aggregation level may start at different locations. The UE 115-a may blind decode the PDCCH candidates regardless of whether the network entity 105-a transmits a control channel message in the resource location. The total quantity of PDCCH candidates across all active search spaces may be the maximum quantity of blind decoding hypotheses on the UE 115-a on multiple carriers. In some cases, the search space configuration may be changed by RRC configuration or RRC reconfiguration, by downlink control information (DCI) signaling including search space set group switching, or by bandwidth part switching with switching of search space configuration because each bandwidth part has an associated search space configuration. The total quantity of PDCCH candidates may generally increase with the quantity of activated carriers. Reducing the maximum quantity of PDCCH decodes (e.g., maximum quantity of monitored PDCCH candidates) may impact scheduling and may increase blocking between two UEs. For example, reducing the configured quantity of monitored control candidates or control resources may negatively impact scheduling by the network entity 105-a, and blocking between two UEs may be more likely.

In some examples, the UE 115-a may monitor the PDCCH candidate(s) 220 and may receive a control channel message 225 transmitted by the network entity 105-a. For example, the control channel message 225 may schedule a downlink data message 230 in a physical downlink shared channel (PDSCH) resource 235. A scheduling offset (K0) or gap between the PDCCH candidate 220 that receives the control channel message 225 and the PDSCH resource 235 for receiving the downlink data message 230 scheduled by the control channel message 225 may be a quantity of slots (e.g., a quantity of TTIs). For the illustrated example in FIG. 2, the scheduling offset (K0) is zero slots. In some cases, the scheduling offset (K0) may be zero slots, one slot or multiple slots. For example, a K0 value of one may indicate that the control channel message 225 received in the PDCCH candidate 220 at a first TTI resource (e.g., slot 0) schedules the downlink data message 230 in the PDSCH resource 235 in the next TTI (e.g., slot 1). In some examples, the minimum value for K0 may be zero. A K0 value of zero may indicate the PDCCH candidate in a TTI and the PDSCH resource in the same TTI. In some cases, the PDSCH resource may occur concurrently with the PDCCH candidate for at least a duration (e.g., the PDCCH candidate and the PDSCH resource may overlap in time for at least a portion of the TTI). In other cases, the PDSCH resource may occur after the PDDCH candidate, but within the same TTI (e.g., the PDSCH resource may follow the PDCCH candidate in the same slot).

In some cases, the control channel message 225 may schedule an uplink data message 240 in a physical uplink shared channel (PUSCH) resource. A scheduling offset (K2) or gap between the PDCCH candidate that receives the control channel message 225 and the PUSCH resource for the uplink data message 240 scheduled by the control channel message 225 may be a quantity of slots, such as zero slots, one slot, or multiple slots. In some cases, a scheduling offset (K1) or gap between the PDSCH resource that receives the downlink data message 230 and the physical uplink control channel (PUCCH) resource for a feedback message 245 (e.g., hybrid repeat request (HARQ) acknowledgment (ACK) or negative acknowledgment (NACK)) may be a quantity of slots, such as zero slots, one slot, or multiple slots.

In some examples, the minimum value for K0, K1, and K2 may be zero slots. In some cases, the UE 115-a may be configured with a minimum scheduling offset (e.g., K0, K2 ). For example, the minimum values for K0 or K2 may be configured per bandwidth part. In some cases, the UE 115-a may receive, from the network entity 105-a, control signaling (e.g., DCI) that indicates a current value for K0 or K2. In some cases, the value for K0 may be indicated as zero, one or some other value, and the value for the scheduling offset may be indicated as temporary.

In some cases, the minimum K0 and K2 value may affect power consumption at the UE 115-a. For example, the UE 115-a may have a limited duration to decode the control channel message 225 (e.g., DCI) received in the PDCCH candidate 220, decode the downlink data message 230 received in the PDSCH resource 235, and prepare the feedback message in the PUCCH resource 250. For example, the UE 115-a may finish receiving the control channel message 225 in the PDCCH candidate 220 at time 255 and have a duration until time 260 to transmit the PDSCH feedback (e.g., in the PUCCH resource 250). During the duration until time 260, the UE 115-a may perform a first decoding operation 265 to decode the DCI received in the PDCCH candidate 220. In some examples, the DCI may include an indication of the K0 value. For example, the DCI may indicate K0 is zero. Based on decoding the DCI, the UE 115-a may perform a second decoding operation 275 to decode the downlink data message 230 received in the PDSCH resource 235 scheduled by the DCI received in PDCCH candidate 220. For example, the DCI may indicate that the scheduled PDSCH resource 235 occurs in the same TTI as the PDCCH candidate 220. Based on the DCI indication, the UE 115-a may decode the downlink data message 230 received in the PDSCH resource 235 and begin a response operation 280. For example, the UE 115-a may prepare to transmit the feedback message 245 (e.g., HARQ message) in the PUCCH resource 250.

Performing the first decoding operation 265, the second decoding operation 275, and the response operation 280 to meet the timeline may increase power consumption for the UE 115-a. In some examples, a K0 value of zero or a K2 value of zero combined with a larger quantity of PDCCH decodes (e.g., monitored PDCCH candidates) may lead to an increase in hardware or increased hardware complexity used for the PDCCH reception to decode the PDCCH candidates within the time duration.

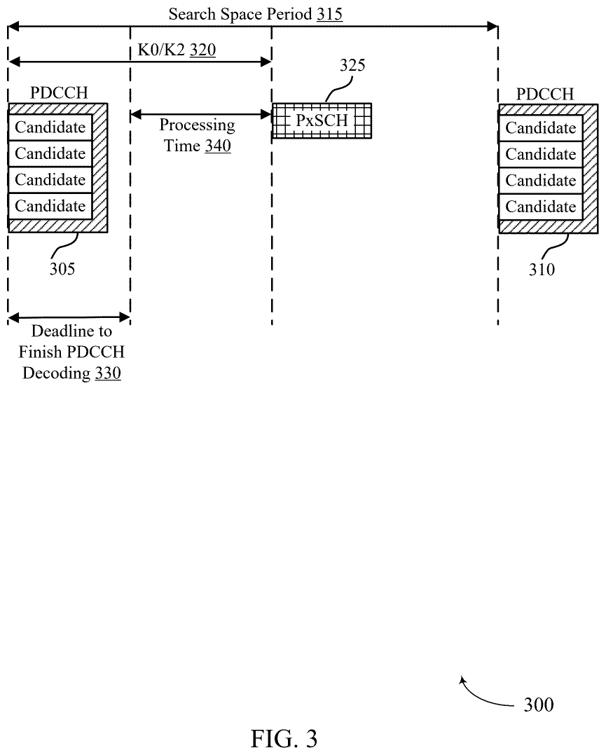

FIG. 3 shows an example of a timing diagram 300 that supports techniques for adjusting a quantity of monitored control candidates or control resources in accordance with one or more aspects of the present disclosure. The timing diagram 300 may implement aspects of or may be implemented by aspects of the wireless communications systems 100 and 200.

FIG. 3 illustrates a first quantity of PDCCH candidates 305 and a second quantity of PDCCH candidates 310. A duration from the start of the first quantity of PDCCH candidates 305 to the start of the second quantity of PDCCH candidates 310 may be a search space period 315 or a control channel monitoring periodicity. A scheduling offset 320 (K0 or K2 ) may be a time duration from the first quantity of PDCCH candidates 305 to the PxSCH resource 325 (e.g., PDSCH resource or PUSCH resource). The UE 115-a may have a time deadline to finish PDCCH decoding 330 and a processing time 340 to prepare for reception or transmission of the signaling on the PxSCH resource 325.

In some examples, a PDCCH decoder throughput criterion may be impacted by a combination of a quantity of PDCCH candidates to be decoded (e.g., monitored control candidates) by a decoding deadline and a size of each PDCCH candidate. The deadlines provided by the minimum scheduling offsets K0 and K2 along with the search space periodicity (e.g., control channel monitoring periodicity) and the quantity PDCCH candidates of each aggregation level may impact the PDCCH decoder throughput. For example, the minimum scheduling offsets K0 and K2 may set the instantaneous throughput criterion and the search space period may set the sustained throughput criterion. In some examples, approaches for adjusting a quantity of monitored control channel candidates or control resources may be desirable to reduce the impact on the UE processing timeline and implementation complexity.

In some examples, the UE 1115-a may monitor a quantity of the configured PDCCH candidates (e.g., monitored control candidates). In some cases, the quantity of PDCCH decodes (e.g., quantity of monitored control candidates) may be a function of the UE 115-a processing time (N1) (e.g., a minimum processing time of the UE 115-a), the scheduling offset (K0 or K2) (e.g., a minimum scheduling offset of the UE 115-a), or both. The processing time (N1) may be a time duration from decoding the PDCCH candidate to be ready for reception of the PDSCH. In some cases, the maximum quantity of monitored control candidates may be a function of the minimum processing time (N1), the minimum scheduling offset (K0 or K2), or both. In some examples, the maximum quantity of CCEs (e.g., maximum quantity of non-overlapped CCEs or control resources) for PDCCH decodes may be a function of the minimum UE 115-a processing time (N1), the minimum scheduling offset (K0 or K2), or both. For example, the quantity of PDCCH decodes (e.g., monitored control candidates) or the quantity of CCEs (e.g., control resources) for PDCCH decodes may be a quantity C when K0 or K2 equal zero (e.g., zero slots or TTIs), and the quantity of PDCCH decodes or the quantity of CCEs for PDCCH decodes may be a quantity 2C when K0 equal two (e.g., greater than or equal to two) or K2 equals three (e.g., 3 slots or TTIs). For example, the quantity of PDCCH decodes or the quantity of CCEs for PDCCH decodes may be a quantity C when NI equals twelve symbols, and the quantity of PDCCH decodes or the quantity of CCEs for PDCCH decodes may be a quantity 2C when NI equals twenty symbols. The maximum quantity of PDCCH decodes may be a quantity of PDCCH decodes that the network entity 105-a may not exceed. In some cases, the maximum quantity of PDCCH decodes may depends on other factors as sub-carrier spacing, UE capability, a quantity of carriers, or any combination thereof.

In some examples, the quantity of PDCCH decodes (e.g., monitored control candidates) or the quantity of control resources may be a function of the control channel monitoring periodicity (e.g., PDCCH monitoring periodicity). For example, if the search space configuration indicates a monitoring periodicity of one slot (e.g., monitor every slot), the quantity monitored control candidates or control resources may be a quantity C. In another example, if the search space configuration indicates a monitoring periodicity of four slots (e.g., monitor every fourth slot), the monitored control candidates or control resources may be a quantity 2C. In some examples, the monitored control candidates or control resources may a function of the UE 115-a processing time (N1), the scheduling offset (K0 or K2), the control channel monitoring periodicity, or a combination thereof.

In some cases, the UE 115-a identify a new quantity or adjusted quantity of monitored control candidates or control resources. In some examples, the UE 115-a may automatically, without signaling, identify a new quantity for the monitored control candidates or control resources after any change in the scheduling offset, the processing timeline, the PDCCH monitoring period, or any combination thereof. For example, the set of monitored control candidates or control resources candidates may be reduced by selecting a subset of the configured candidates when the maximum quantity of decodes is reduced, and the set of PDCCH candidates may be expanded to include a larger subset (or all) of the configured candidates. In some cases, the alternative configured set of PDCCH candidates may be applied when the maximum quantity of PDCCH decodes is changed. For example, a plurality of subsets of monitored control candidates or control resources may be configured, and each of the subsets may include a different quantity of monitored control candidates or control resources. The UE 115-a may select one of the configured subsets corresponding to the desired quantity. In some cases, the UE 115-a may applying an alternative hashing function or a modified hashing function to the configured plurality of monitored control candidates or control resources to identify the new subset of the plurality of monitored control candidates or control resources. For example, the input to the hashing function may be an identifier of the UE 115-a, a PDCCH candidate index, or a slot index, and the output of the hashing function may be a quantity of monitored control candidates or control resources.

In some examples, the UE 115-a may receive, from the network entity 105-a, control signaling indicating the quantity of monitored control candidates or control resources. For example, the UE 115-a may receive RRC signaling, MAC-CE, or DCI indicating the maximum quantity of control candidates or control resources to monitor. In some cases, the network entity 105-a may transmit control signaling indicating a subset of the monitored control candidates or control resources, such as configured subset one or subset two. In some cases, the control signaling may indicate search space set group (SSSG) switching or reconfiguration (e.g., indicate a switch from a first SSSG to a second SSSG), bandwidth part switching or reconfiguration (e.g., indicate a switch from a first bandwidth part to a second bandwidth part), or both, may indicate the maximum quantity of monitored control candidates or control resources. For example, a first SSSG may be associated with a first maximum quantity of monitored control candidates or control resources, and a second SSSG may be associated with a second maximum quantity of monitored control candidates or control resources. The network entity 105-a may transmit control signaling may indicating a switch from the first SSSG to the second SSSG, and the maximum quantity of monitored control candidates or control resources monitored by the UE 115-a may be the maximum quantity of monitored control candidates or control resources associated with the second SSSG.

In another example, a first bandwidth part may be associated with a first maximum quantity of monitored control candidates or control resources, and a second bandwidth part may be associated with a second maximum quantity of monitored control candidates or control resources. The network entity 105-a may transmit control signaling may indicating a switch from the first bandwidth part to the second bandwidth part, and the maximum quantity of monitored control candidates or control resources monitored by the UE 115-a may be the maximum quantity of monitored control candidates or control resources associated with the second bandwidth part. In some cases, the network entity 105-a transmit control signaling that indicates an index to an alternative set of monitored control candidates or control resources similar to SSSG switching with the candidates per aggregation level change without affecting other search space configurations.

In some cases, the UE 115-a may transmit control signaling, to the network entity 105-a, indicating the quantity of monitored control candidates or control resources that the UE 115-a is capable of supporting for one or more minimum scheduling offsets (e.g., K0, K2 ), for one or more minimum processing timelines, for one or more PDCCH monitoring periodicities, or any combination thereof. In some examples, the UE 115-a may indicate the quantity of monitored control candidates or control resources supported for a minimum scheduling offset in UE capability reporting.

In some cases, the quantity of monitored control candidates or control resources may be indicated or defined as an absolute maximum numerical value (Cₘₐₓ). In some cases, the quantity of monitored control candidates or control resources may be indicated or defined as a limit on a ratio of the quantity of monitored control candidates or control resources over the downlink or uplink (joint or separate limit) scheduling offset (R_{sched}). In some cases, the quantity of monitored control candidates or control resources may be indicated or defined as a limit on a ratio of the quantity of monitored control candidates or control resources over the PDCCH monitoring periodicity (R_{PDCCH}). In some cases, the quantity of monitored control candidates or control resources may be indicated or defined as a limit on a ratio of the quantity of monitored control candidates or control resources over the processing time (R_{proc}). In some examples, the quantity of monitored control candidates or control resources C may be valid if C<=Cₘₐₓ, C/(minimum scheduling offset)<=R_{sched}, and reduce C or increase minimum scheduling offset; optionally, C/(PDCCH monitoring periodicity)<=R_{PDCCH} or optionally C/(processing time),<=R_{proc}. If separate thresholds are defined for downlink and uplink minimum scheduling offset, then C/(minimum scheduling offset)<=R_{sched} may be replaced with two conditions, one for downlink and one for uplink minimum scheduling offsets.

In some examples, if monitoring of downlink and uplink grants becomes separate, the quantity of monitored control candidates or control resources may be separately calculated for uplink and downlink grants based on the corresponding minimum scheduling offset and processing timeline. For example, the quantity of monitored control candidates or control resources for uplink grants may be calculated based on the minimum scheduling offset for uplink. For example, the quantity of monitored control candidates or control resources for downlink grants may be calculated based on the minimum scheduling offset for downlink. In some examples, quantity of monitored control candidates or control resources may be calculated for different DCI formats and the timelines associated with the respective DCI formats. In some cases, an overall limit for the maximum quantity of monitored control candidates or control resources may be set.

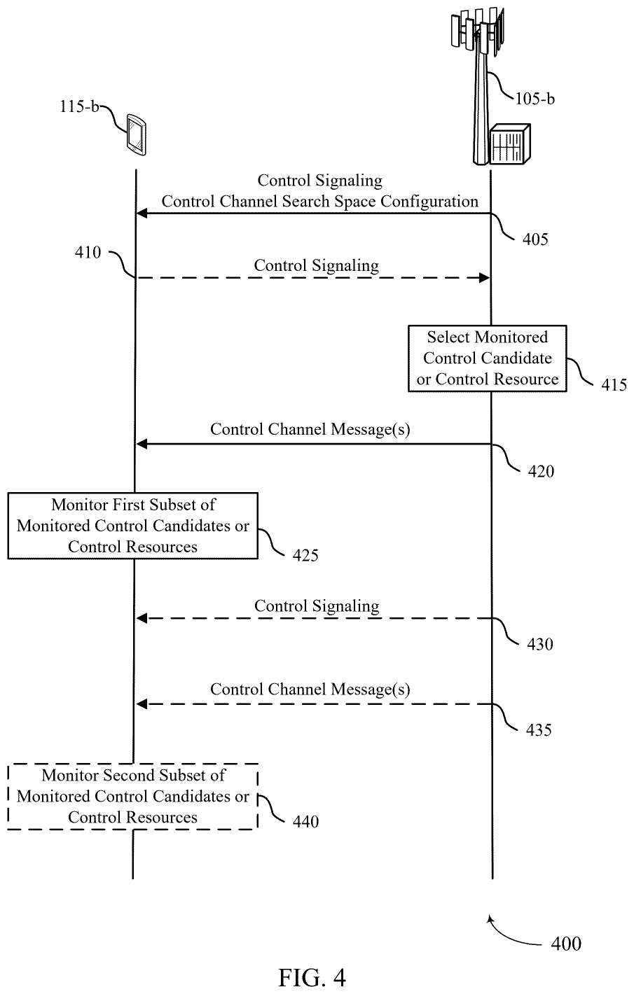

FIG. 4 shows an example of a process flow 400 that supports techniques for adjusting a quantity of monitored control candidates or control resources in accordance with one or more aspects of the present disclosure. In some examples, the process flow 400 may implement or be implemented by aspects of the wireless communications systems 100 and 200 as described with reference to FIGS. 1 and 2, respectively. For example, the process flow 400 may be implemented by a network entity 105-b, which may be an example of the network entities 105 as described with reference to FIGS. 1 and 2. The process flow 400 may be implemented by a UE 115-b, which may be an example of the UEs as described with reference to FIGS. 1 and 2.

In some examples, the operations illustrated in process flow 400 may be performed by hardware (e.g., including circuitry, processing blocks, logic components, and other components), code (e.g., software executed by a processor), or any combination thereof. Alternative examples of the following may be implemented, where some steps are performed in a different order than described or are not performed at all. In some cases, steps may include additional features not mentioned below, or further steps may be added.

At 405, the UE 115-b may receive, from the network entity 105-b, first control signaling indicating a control channel search space configuration. The control channel search space configuration may include a plurality of monitored control candidates or control resources of a control channel.

At 410, the UE 115-b may transmit, to the network entity 105-b subsequent to receiving the first control signaling, control signaling that indicates a first quantity of the plurality of monitored control candidates or control resources that the UE 115-b will monitor. In some examples, the control signaling indicating the first quantity may include a quantity of monitored control candidates, a limit associated with a ratio of the quantity of monitored control candidates to the minimum scheduling offset, a limit associated with a ratio of the quantity of monitored control candidates to a control channel monitoring periodicity, a limit associated with a ratio of the quantity of monitored control candidates to the processing time, or any combination thereof.

At 415, the network entity 105-b may select a first monitored control candidate or control resource from a first subset of the plurality of monitored control candidates or control resources. The first subset of the plurality of monitored control candidates or control resources comprises a first quantity of the plurality of monitored control candidates or control resources, and the first quantity may be based on a processing time associated with the UE 115-b, a minimum scheduling offset associated with the UE 115-b, or both. In some examples, the first quantity may be based on a control channel monitoring periodicity. In some examples, the first quantity may be based on processing time associated with an uplink grant, the minimum scheduling offset associated with the uplink grant, or both. In some examples, first quantity may be based on the processing time associated with a downlink grant, the minimum scheduling offset associated with the downlink grant, or both. In some examples, the first quantity may be based on a downlink control information format

At 420, the network entity 105-b may output, to the UE 115-b, one or more first control channel messages via the first monitored control candidate or control resource.

At 425, the UE 115-b may monitor a first subset of the plurality of monitored control candidates or control resources for a control channel message. The first subset of the plurality of monitored control candidates or control resources may include a first quantity of the plurality of monitored control candidates or control resources, and the first quantity may be based on a processing time associated with the UE, a minimum scheduling offset associated with the UE, or both. In some examples, the first quantity may be based on a control channel monitoring periodicity.

At 430, the UE 115-b may receive, from the network entity 105-b subsequent to monitoring the first subset of the plurality of monitored control candidates or control resources, control signaling that indicates a second quantity of the plurality of monitored control candidates or control resources.

At 435, the network entity 105-b may output, to the UE 115-b, one or more second control channel messages via the second monitored control candidate or control resource.

At 440, the UE 115-b may monitor a second subset of the plurality of monitored control candidates or control resources, and the second subset of the plurality of monitored control candidates or control resources may include a second quantity of the plurality of monitored control candidates or control resources. In some examples, the second quantity of the plurality of monitored control candidates or control resources may be based on a change in the processing time, a change in the minimum scheduling offset, a change in a control channel monitoring periodicity, or any combination thereof. In some examples, the second quantity may be greater than or less than the first quantity. In some examples, the UE 115-b may select the second subset from a plurality of subsets of the plurality of monitored control candidates or control resources, and the control channel search space configuration may include the plurality of subsets. Each of the plurality of subsets may include a different quantity of the plurality of monitored control candidates or control resources.

In some examples, the UE 115-b may apply a hashing function to the plurality of monitored control candidates or control resources to identify the second subset of the plurality of monitored control candidates or control resources.

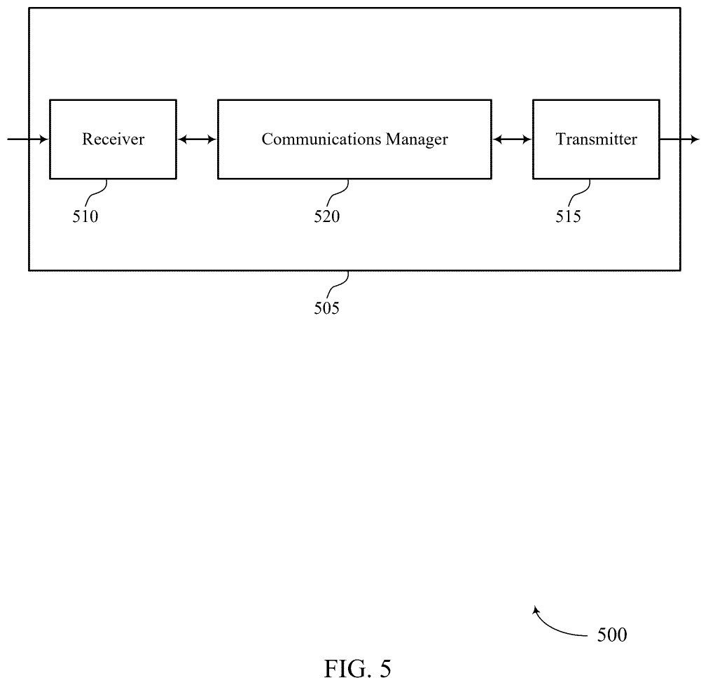

FIG. 5 shows a block diagram 500 of a device 505 that supports techniques for adjusting a quantity of monitored control candidates or control resources in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for adjusting a quantity of monitored control candidates or control resources). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for adjusting a quantity of monitored control candidates or control resources). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of techniques for adjusting a quantity of monitored control candidates or control resources as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. For example, the communications manager 520 is capable of, configured to, or operable to support a means for receiving, from a network entity, first control signaling indicating a control channel search space configuration, where the control channel search space configuration includes a set of multiple monitored control candidates or control resources of a control channel. The communications manager 520 is capable of, configured to, or operable to support a means for monitoring a first subset of the set of multiple monitored control candidates or control resources for a control channel message, where the first subset of the set of multiple monitored control candidates or control resources includes a first quantity of the set of multiple monitored control candidates or control resources, and where the first quantity is based on a processing time associated with the UE, a minimum scheduling offset associated with the UE, or both.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced power consumption and more efficient utilization of communication resources.

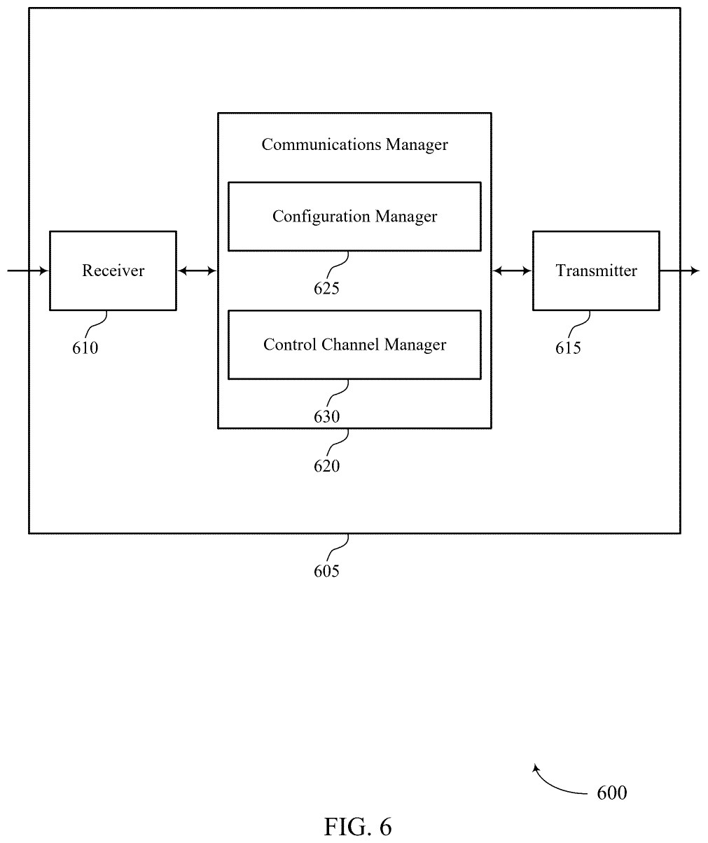

FIG. 6 shows a block diagram 600 of a device 605 that supports techniques for adjusting a quantity of monitored control candidates or control resources in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for adjusting a quantity of monitored control candidates or control resources). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for adjusting a quantity of monitored control candidates or control resources). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for adjusting a quantity of monitored control candidates or control resources as described herein. For example, the communications manager 620 may include a configuration manager 625 a control channel manager 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. The configuration manager 625 is capable of, configured to, or operable to support a means for receiving, from a network entity, first control signaling indicating a control channel search space configuration, where the control channel search space configuration includes a set of multiple monitored control candidates or control resources of a control channel. The control channel manager 630 is capable of, configured to, or operable to support a means for monitoring a first subset of the set of multiple monitored control candidates or control resources for a control channel message, where the first subset of the set of multiple monitored control candidates or control resources includes a first quantity of the set of multiple monitored control candidates or control resources, and where the first quantity is based on a processing time associated with the UE, a minimum scheduling offset associated with the UE, or both.

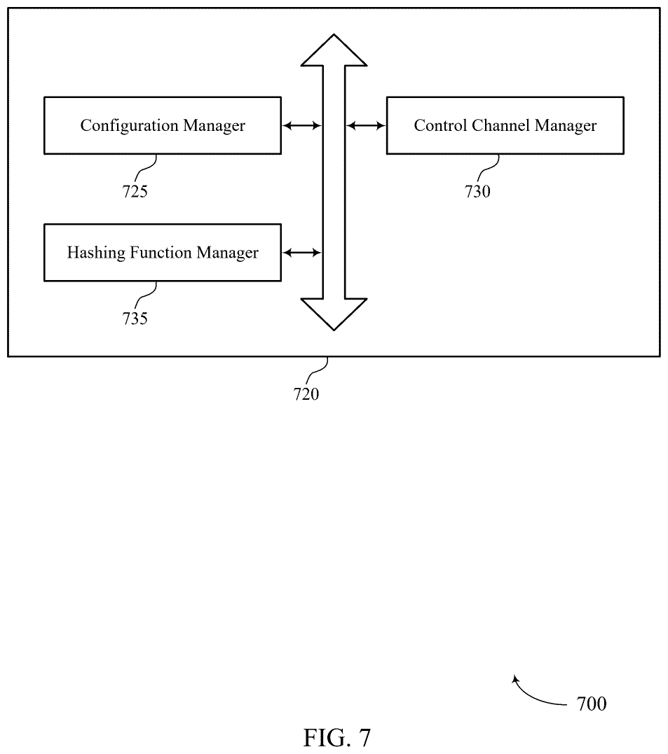

FIG. 7 shows a block diagram 700 of a communications manager 720 that supports techniques for adjusting a quantity of monitored control candidates or control resources in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for adjusting a quantity of monitored control candidates or control resources as described herein. For example, the communications manager 720 may include a configuration manager 725, a control channel manager 730, a hashing function manager 735, or any combination thereof. Each of these components, or components or subcomponents thereof (e.g., one or more processors, one or more memories), may communicate, directly or indirectly, with one another (e.g., via one or more buses).

The communications manager 720 may support wireless communication in accordance with examples as disclosed herein. The configuration manager 725 is capable of, configured to, or operable to support a means for receiving, from a network entity, first control signaling indicating a control channel search space configuration, where the control channel search space configuration includes a set of multiple monitored control candidates or control resources of a control channel. The control channel manager 730 is capable of, configured to, or operable to support a means for monitoring a first subset of the set of multiple monitored control candidates or control resources for a control channel message, where the first subset of the set of multiple monitored control candidates or control resources includes a first quantity of the set of multiple monitored control candidates or control resources, and where the first quantity is based on a processing time associated with the UE, a minimum scheduling offset associated with the UE, or both.

In some examples, the first quantity is based on a control channel monitoring periodicity.

In some examples, the control channel manager 730 is capable of, configured to, or operable to support a means for monitoring a second subset of the set of multiple monitored control candidates or control resources, where the second subset of the set of multiple monitored control candidates or control resources includes a second quantity of the set of multiple monitored control candidates or control resources that is based on a change in the processing time, a change in the minimum scheduling offset, a change in a control channel monitoring periodicity, or any combination thereof.

In some examples, the second quantity is greater than or less than the first quantity.

In some examples, to support monitoring the second subset, the control channel manager 730 is capable of, configured to, or operable to support a means for selecting the second subset from a set of multiple subsets of the set of multiple monitored control candidates or control resources, where the control channel search space configuration includes the set of multiple subsets, and where each of the set of multiple subsets include a different quantity of the set of multiple monitored control candidates or control resources.

In some examples, the hashing function manager 735 is capable of, configured to, or operable to support a means for applying a hashing function to the set of multiple monitored control candidates or control resources to identify the second subset of the set of multiple monitored control candidates or control resources.

In some examples, the control channel manager 730 is capable of, configured to, or operable to support a means for receiving, from the network entity subsequent to monitoring the first subset of the set of multiple monitored control candidates or control resources, second control signaling that indicates a second quantity of the set of multiple monitored control candidates or control resources. In some examples, the control channel manager 730 is capable of, configured to, or operable to support a means for monitoring a second subset of the set of multiple monitored control candidates or control resources, where the second subset of the set of multiple monitored control candidates or control resources includes a second quantity of the set of multiple monitored control candidates or control resources.

In some examples, the control channel manager 730 is capable of, configured to, or operable to support a means for transmitting, to the network entity subsequent to receiving the first control signaling, second control signaling that indicates the first quantity.

In some examples, the second control signaling that indicates the first quantity includes a quantity of monitored control candidates, a limit associated with a ratio of the quantity of monitored control candidates to the minimum scheduling offset, a limit associated with a ratio of the quantity of monitored control candidates to a control channel monitoring periodicity, a limit associated with a ratio of the quantity of monitored control candidates to the processing time, or any combination thereof.

In some examples, the first quantity is based on the processing time associated with an uplink grant, the minimum scheduling offset associated with the uplink grant, or both.

In some examples, the first quantity is based on the processing time associated with a downlink grant, the minimum scheduling offset associated with the downlink grant, or both.

In some examples, the first quantity is based on a downlink control information format.

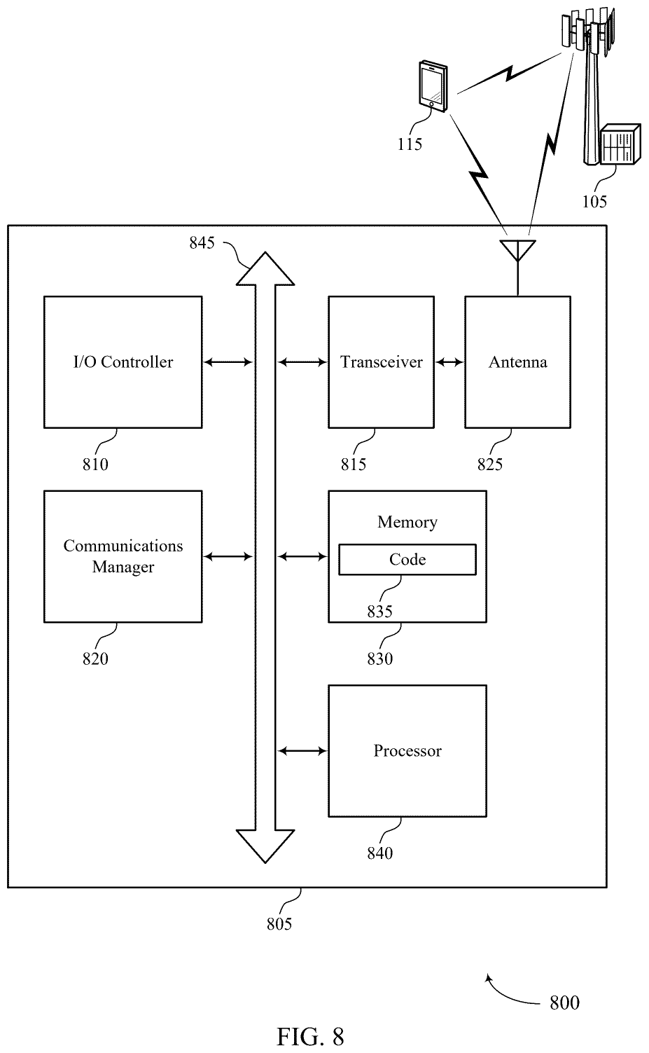

FIG. 8 shows a diagram of a system 800 including a device 805 that supports techniques for adjusting a quantity of monitored control candidates or control resources in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for adjusting a quantity of monitored control candidates or control resources). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communication in accordance with examples as disclosed herein. For example, the communications manager 820 is capable of, configured to, or operable to support a means for receiving, from a network entity, first control signaling indicating a control channel search space configuration, where the control channel search space configuration includes a set of multiple monitored control candidates or control resources of a control channel. The communications manager 820 is capable of, configured to, or operable to support a means for monitoring a first subset of the set of multiple monitored control candidates or control resources for a control channel message, where the first subset of the set of multiple monitored control candidates or control resources includes a first quantity of the set of multiple monitored control candidates or control resources, and where the first quantity is based on a processing time associated with the UE, a minimum scheduling offset associated with the UE, or both.

By including or configuring the communications manager 820 in accordance with examples as described herein, the device 805 may support techniques for reduced latency, reduced power consumption, more efficient utilization of communication resources, improved coordination between devices, and longer battery life.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for adjusting a quantity of monitored control candidates or control resources as described herein, or the at least one processor 840 and the at least one memory 830 may be otherwise configured to, individually or collectively, perform or support such operations.

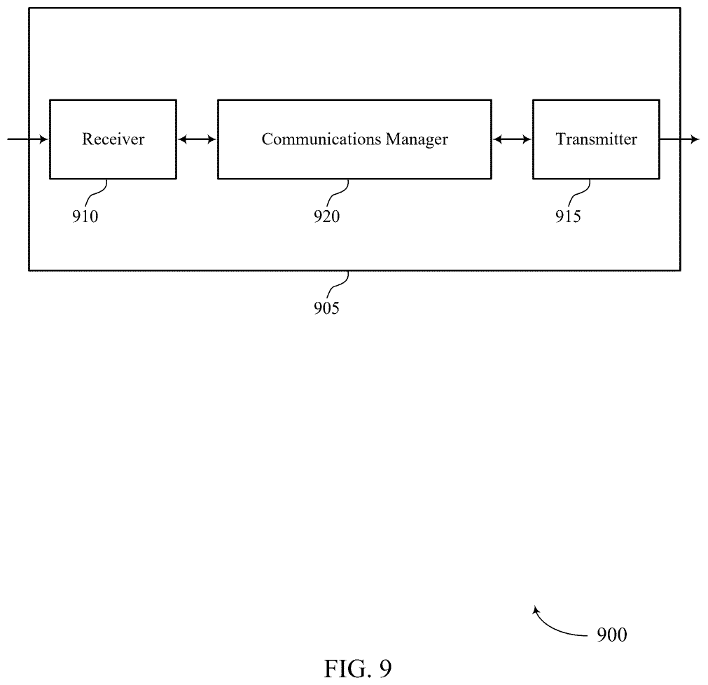

FIG. 9 shows a block diagram 900 of a device 905 that supports techniques for adjusting a quantity of monitored control candidates or control resources in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of techniques for adjusting a quantity of monitored control candidates or control resources as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. For example, the communications manager 920 is capable of, configured to, or operable to support a means for outputting, to a UE, first control signaling indicating a control channel search space configuration, where the control channel search space configuration includes a set of multiple monitored control candidates or control resources of a control channel. The communications manager 920 is capable of, configured to, or operable to support a means for selecting a first resource monitored control candidate or control resource candidate from a first subset of the set of multiple monitored control candidates or control resources, where the first subset of the set of multiple monitored control candidates or control resources includes a first quantity of the set of multiple monitored control candidates or control resources, and where the first quantity is based on a processing time associated with the UE, a minimum scheduling offset associated with the UE, or both. The communications manager 920 is capable of, configured to, or operable to support a means for outputting, to the UE, one or more first control channel messages via the first monitored control candidate or control resource.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced power consumption and more efficient utilization of communication resources.

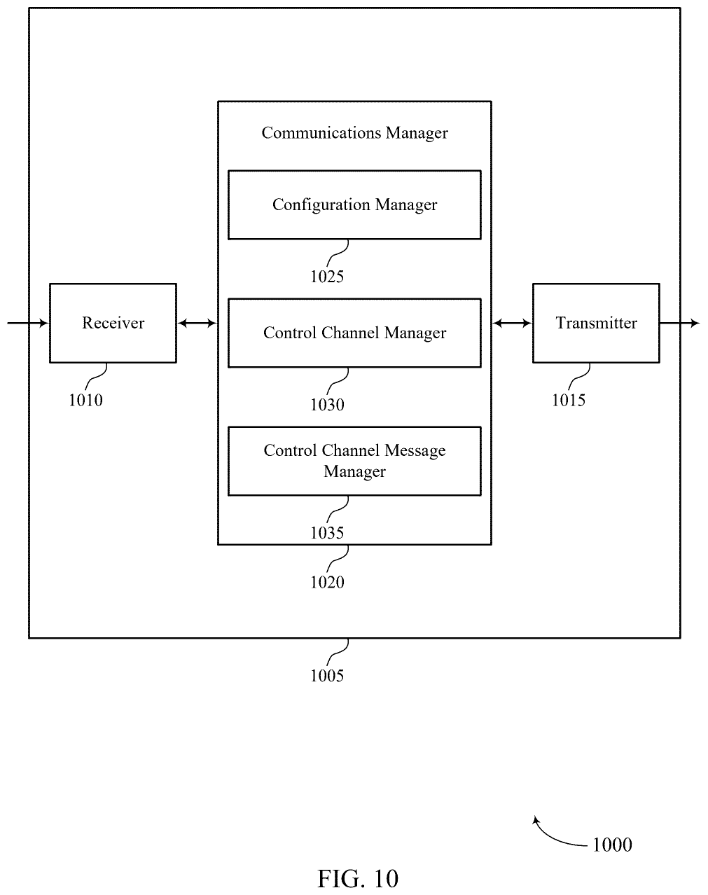

FIG. 10 shows a block diagram 1000 of a device 1005 that supports techniques for adjusting a quantity of monitored control candidates or control resources in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for adjusting a quantity of monitored control candidates or control resources as described herein. For example, the communications manager 1020 may include a configuration manager 1025, a control channel manager 1030, a control channel message manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. The configuration manager 1025 is capable of, configured to, or operable to support a means for outputting, to a UE, first control signaling indicating a control channel search space configuration, where the control channel search space configuration includes a set of multiple monitored control candidates or control resources of a control channel. The control channel manager 1030 is capable of, configured to, or operable to support a means for selecting a first resource candidate from a first subset of the set of multiple monitored control candidates or control resources, where the first subset of the set of multiple monitored control candidates or control resources includes a first quantity of the set of multiple monitored control candidates or control resources, and where the first quantity is based on a processing time associated with the UE, a minimum scheduling offset associated with the UE, or both. The control channel message manager 1035 is capable of, configured to, or operable to support a means for outputting, to the UE, one or more first control channel messages via the first monitored control candidate or control resource.

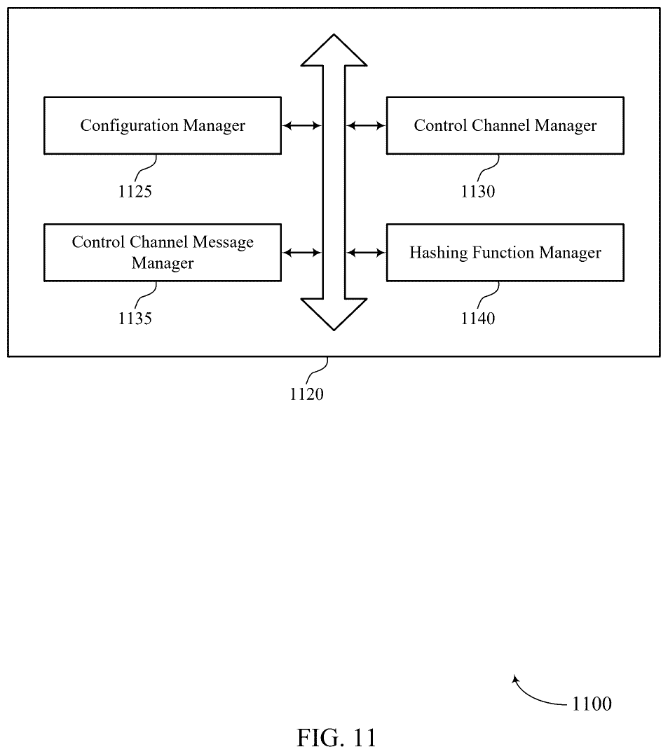

FIG. 11 shows a block diagram 1100 of a communications manager 1120 that supports techniques for adjusting a quantity of monitored control candidates or control resources in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for adjusting a quantity of monitored control candidates or control resources as described herein. For example, the communications manager 1120 may include a configuration manager 1125, a control channel manager 1130, a control channel message manager 1135, a hashing function manager 1140, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication in accordance with examples as disclosed herein. The configuration manager 1125 is capable of, configured to, or operable to support a means for outputting, to a UE, first control signaling indicating a control channel search space configuration, where the control channel search space configuration includes a set of multiple monitored control candidates or control resources of a control channel. The control channel manager 1130 is capable of, configured to, or operable to support a means for selecting a first monitored control candidate or control resource from a first subset of the set of multiple monitored control candidates or control resources, where the first subset of the set of multiple monitored control candidates or control resources includes a first quantity of the set of multiple monitored control candidates or control resources, and where the first quantity is based on a processing time associated with the UE, a minimum scheduling offset associated with the UE, or both. The control channel message manager 1135 is capable of, configured to, or operable to support a means for outputting, to the UE, one or more first control channel messages via the first monitored control candidate or control resource.

In some examples, the first quantity is based on a control channel monitoring periodicity.

In some examples, the control channel message manager 1135 is capable of, configured to, or operable to support a means for outputting, to the UE, one or more second control channel messages via a second monitored control candidate or control resource selected from a second subset of the set of multiple monitored control candidates or control resources, where the second subset of the set of multiple monitored control candidates or control resources includes a second quantity of the set of multiple monitored control candidates or control resources that is based on a change in the processing time, a change in the minimum scheduling offset, a change in a control channel monitoring periodicity, or any combination thereof.

In some examples, the second quantity is greater than or less than the first quantity.

In some examples, the hashing function manager 1140 is capable of, configured to, or operable to support a means for applying a hashing function to the set of multiple monitored control candidates or control resources to identify the second subset of the set of multiple monitored control candidates or control resources.

In some examples, the control channel manager 1130 is capable of, configured to, or operable to support a means for outputting, to the UE subsequent to the one or more first control channel messages, second control signaling that indicates a second quantity of the set of multiple monitored control candidates or control resources. In some examples, the control channel message manager 1135 is capable of, configured to, or operable to support a means for outputting, to the UE, one or more second control channel messages via a second monitored control candidate or control resource selected from a second subset of the set of multiple monitored control candidates or control resources, where the second subset of the set of multiple monitored control candidates or control resources includes the second quantity of the set of multiple monitored control candidates or control resources.

In some examples, the control channel manager 1130 is capable of, configured to, or operable to support a means for receiving, from the UE subsequent to the first control signaling, second control signaling that indicates the first quantity.

In some examples, the second control signaling that indicates the first quantity includes a quantity of monitored control candidates, a limit associated with a ratio of the quantity of monitored control candidates to the minimum scheduling offset, a limit associated with a ratio of the quantity of monitored control candidates to a control channel monitoring periodicity, a limit associated with a ratio of the quantity of monitored control candidates to the processing time, or any combination thereof.

In some examples, the first quantity is based on the processing time associated with an uplink grant, the minimum scheduling offset associated with the uplink grant, or both.

In some examples, the first quantity is based on the processing time associated with a downlink grant, the minimum scheduling offset associated with the downlink grant, or both.

In some examples, the first quantity is based on a downlink control information format.

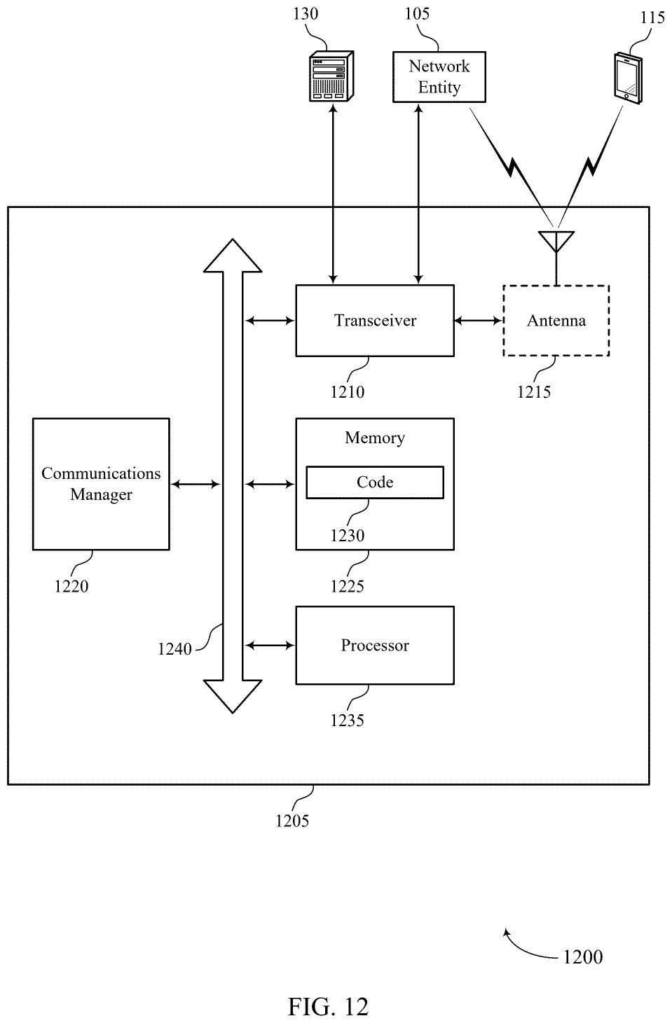

FIG. 12 shows a diagram of a system 1200 including a device 1205 that supports techniques for adjusting a quantity of monitored control candidates or control resources in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting techniques for adjusting a quantity of monitored control candidates or control resources). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communication in accordance with examples as disclosed herein. For example, the communications manager 1220 is capable of, configured to, or operable to support a means for outputting, to a UE, first control signaling indicating a control channel search space configuration, where the control channel search space configuration includes a set of multiple monitored control candidates or control resources of a control channel. The communications manager 1220 is capable of, configured to, or operable to support a means for selecting a first monitored control candidate or control resource from a first subset of the set of multiple monitored control candidates or control resources, where the first subset of the set of multiple monitored control candidates or control resources includes a first quantity of the set of multiple monitored control candidates or control resources, and where the first quantity is based on a processing time associated with the UE, a minimum scheduling offset associated with the UE, or both. The communications manager 1220 is capable of, configured to, or operable to support a means for outputting, to the UE, one or more first control channel messages via the first monitored control candidate or control resource.

By including or configuring the communications manager 1220 in

accordance with examples as described herein, the device 1205 may support techniques for reduced latency, reduced power consumption, more efficient utilization of communication resources, and improved coordination between devices.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of techniques for adjusting a quantity of monitored control candidates or control resources as described herein, or the at least one processor 1235 and the at least one memory 1225 may be otherwise configured to, individually or collectively, perform or support such operations.

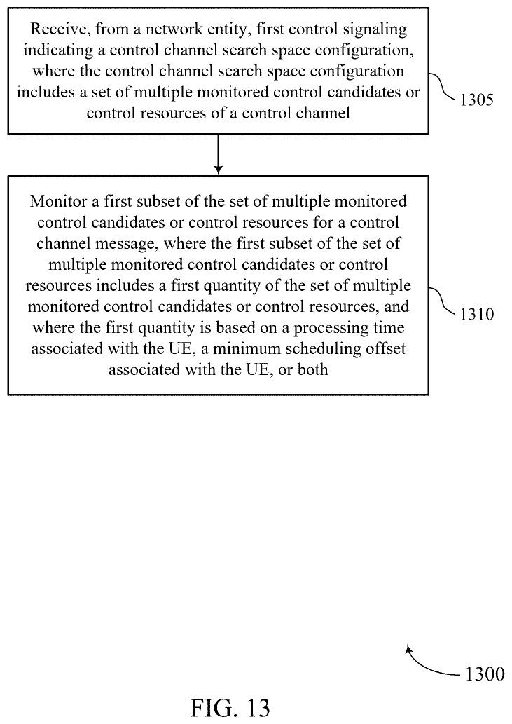

FIG. 13 shows a flowchart illustrating a method 1300 that supports techniques for adjusting a quantity of monitored control candidates or control resources in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving, from a network entity, first control signaling indicating a control channel search space configuration, where the control channel search space configuration includes a set of multiple monitored control candidates or control resources of a control channel. The operations of 1305 may be performed in accordance with examples as disclosed herein. In some examples, aspects of the operations of 1305 may be performed by a configuration manager 725 as described with reference to FIG. 7.

At 1310, the method may include monitoring a first subset of the set of multiple monitored control candidates or control resources for a control channel message, where the first subset of the set of multiple monitored control candidates or control resources includes a first quantity of the set of multiple monitored control candidates or control resources, and where the first quantity is based on a processing time associated with the UE, a minimum scheduling offset associated with the UE, or both. The operations of 1310 may be performed in accordance with examples as disclosed herein. In some examples, aspects of the operations of 1310 may be performed by a control channel manager 730 as described with reference to FIG. 7.

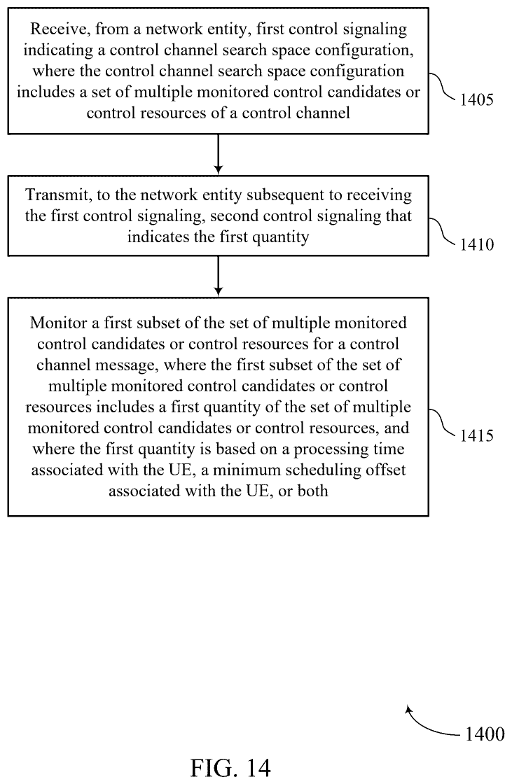

FIG. 14 shows a flowchart illustrating a method 1400 that supports techniques for adjusting a quantity of monitored control candidates or control resources in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving, from a network entity, first control signaling indicating a control channel search space configuration, where the control channel search space configuration includes a set of multiple monitored control candidates or control resources of a control channel. The operations of 1405 may be performed in accordance with examples as disclosed herein. In some examples, aspects of the operations of 1405 may be performed by a configuration manager 725 as described with reference to FIG. 7.

At 1410, the method may include transmitting, to the network entity subsequent to receiving the first control signaling, second control signaling that indicates the first quantity. The operations of 1410 may be performed in accordance with examples as disclosed herein. In some examples, aspects of the operations of 1410 may be performed by a control channel manager 730 as described with reference to FIG. 7.

At 1415, the method may include monitoring a first subset of the set of multiple monitored control candidates or control resources for a control channel message, where the first subset of the set of multiple monitored control candidates or control resources includes a first quantity of the set of multiple monitored control candidates or control resources, and where the first quantity is based on a processing time associated with the UE, a minimum scheduling offset associated with the UE, or both. The operations of 1415 may be performed in accordance with examples as disclosed herein. In some examples, aspects of the operations of 1415 may be performed by a control channel manager 730 as described with reference to FIG. 7.

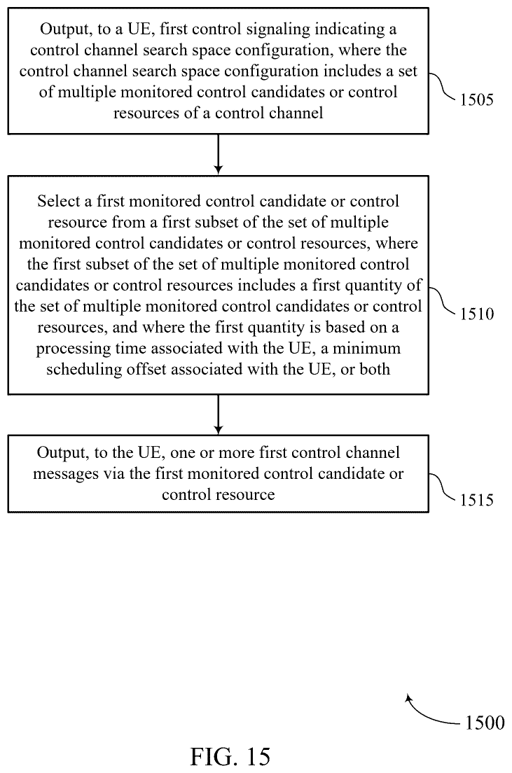

FIG. 15 shows a flowchart illustrating a method 1500 that supports techniques for adjusting a quantity of monitored control candidates or control resources in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include outputting, to a UE, first control signaling indicating a control channel search space configuration, where the control channel search space configuration includes a set of multiple monitored control candidates or control resources of a control channel. The operations of 1505 may be performed in accordance with examples as disclosed herein. In some examples, aspects of the operations of 1505 may be performed by a configuration manager 1125 as described with reference to FIG. 11.

At 1510, the method may include selecting a first monitored control candidate or control resource from a first subset of the set of multiple monitored control candidates or control resources, where the first subset of the set of multiple monitored control candidates or control resources includes a first quantity of the set of multiple monitored control candidates or control resources, and where the first quantity is based on a processing time associated with the UE, a minimum scheduling offset associated with the UE, or both. The operations of 1510 may be performed in accordance with examples as disclosed herein. In some examples, aspects of the operations of 1510 may be performed by a control channel manager 1130 as described with reference to FIG. 11.

At 1515, the method may include outputting, to the UE, one or more first control channel messages via the first monitored control candidate or control resource. The operations of 1515 may be performed in accordance with examples as disclosed herein. In some examples, aspects of the operations of 1515 may be performed by a control channel message manager 1135 as described with reference to FIG. 11.

The following provides an overview of aspects of the present disclosure:

Aspect 1: A method for wireless communication by a UE, comprising: receiving, from a network entity, first control signaling indicating a control channel search space configuration, wherein the control channel search space configuration comprises a plurality of monitored control candidates or control resources of a control channel; and monitoring a first subset of the plurality of monitored control candidates or control resources for a control channel message, wherein the first subset of the plurality of monitored control candidates or control resources comprises a first quantity of the plurality of monitored control candidates or control resources, and wherein the first quantity is based at least in part on a processing time associated with the UE, a minimum scheduling offset associated with the UE, or both.

Aspect 2: The method of aspect 1, wherein the first quantity is based at least in part on a control channel monitoring periodicity.

Aspect 3: The method of any of aspects 1 through 2, further comprising: monitoring a second subset of the plurality of monitored control candidates or control resources, wherein the second subset of the plurality of monitored control candidates or control resources comprises a second quantity of the plurality of monitored control candidates or control resources that is based at least in part on a change in the processing time, a change in the minimum scheduling offset, a change in a control channel monitoring periodicity, or any combination thereof.

Aspect 4: The method of aspect 3, wherein the second quantity is greater than or less than the first quantity.

Aspect 5: The method of any of aspects 3 through 4, wherein monitoring the second subset further comprises: selecting the second subset from a plurality of subsets of the plurality of monitored control candidates or control resources, wherein the control channel search space configuration comprises the plurality of subsets, and wherein each of the plurality of subsets comprise a different quantity of the plurality of monitored control candidates or control resources.

Aspect 6: The method of any of aspects 3 through 5, further comprising: applying a hashing function to the plurality of monitored control candidates or control resources to identify the second subset of the plurality of monitored control candidates or control resources.

Aspect 7: The method of any of aspects 1 through 6, further comprising: receiving, from the network entity subsequent to monitoring the first subset of the plurality of monitored control candidates or control resources, second control signaling that indicates a second quantity of the plurality of monitored control candidates or control resources; and monitoring a second subset of the plurality of monitored control candidates or control resources, wherein the second subset of the plurality of monitored control candidates or control resources comprises a second quantity of the plurality of monitored control candidates or control resources.

Aspect 8: The method of any of aspects 1 through 7, further comprising: transmitting, to the network entity subsequent to receiving the first control signaling, second control signaling that indicates the first quantity.

Aspect 9: The method of aspect 8, wherein the second control signaling that indicates the first quantity comprises a quantity of monitored control candidates, a limit associated with a ratio of the quantity of monitored control candidates to the minimum scheduling offset, a limit associated with a ratio of the quantity of monitored control candidates to a control channel monitoring periodicity, a limit associated with a ratio of the quantity of monitored control candidates to the processing time, or any combination thereof.

Aspect 10: The method of aspect 1, wherein the first quantity is based at least in part on the processing time associated with an uplink grant, the minimum scheduling offset associated with the uplink grant, or both.

Aspect 11: The method of aspect 1, wherein the first quantity is based at least in part on the processing time associated with a downlink grant, the minimum scheduling offset associated with the downlink grant, or both.

Aspect 12: The method of aspect 1, wherein the first quantity is based at least in part on a downlink control information format.

Aspect 13: A method for wireless communication by a network entity, comprising: outputting, to a UE, first control signaling indicating a control channel search space configuration, wherein the control channel search space configuration comprises a plurality of monitored control candidates or control resources of a control channel; selecting a first monitored control candidate or control resource from a first subset of the plurality of monitored control candidates or control resources, wherein the first subset of the plurality of monitored control candidates or control resources comprises a first quantity of the plurality of monitored control candidates or control resources, and wherein the first quantity is based at least in part on a processing time associated with the UE, a minimum scheduling offset associated with the UE, or both; and outputting, to the UE, one or more first control channel messages via the first monitored control candidate or control resource.

Aspect 14: The method of aspect 13, wherein the first quantity is based at least in part on a control channel monitoring periodicity.

Aspect 15: The method of any of aspects 13 through 14, further comprising: outputting, to the UE, one or more second control channel messages via a second monitored control candidate or control resource selected from a second subset of the plurality of monitored control candidates or control resources, wherein the second subset of the plurality of monitored control candidates or control resources comprises a second quantity of the plurality of monitored control candidates or control resources that is based at least in part on a change in the processing time, a change in the minimum scheduling offset, a change in a control channel monitoring periodicity, or any combination thereof.

Aspect 16: The method of aspect 15, wherein the second quantity is greater than or less than the first quantity.

Aspect 17: The method of any of aspects 15 through 16, further comprising: applying a hashing function to the plurality of monitored control candidates or control resources to identify the second subset of the plurality of monitored control candidates or control resources.

Aspect 18: The method of any of aspects 13 through 17, further comprising: outputting, to the UE subsequent to the one or more first control channel messages, second control signaling that indicates a second quantity of the plurality of monitored control candidates or control resources; and outputting, to the UE, one or more second control channel messages via a second monitored control candidate or control resource selected from a second subset of the plurality of monitored control candidates or control resources, wherein the second subset of the plurality of monitored control candidates or control resources comprises the second quantity of the plurality of monitored control candidates or control resources.

Aspect 19: The method of any of aspects 13 through 18, further comprising: receiving, from the UE subsequent to the first control signaling, second control signaling that indicates the first quantity.

Aspect 20: The method of aspect 19, wherein the second control signaling that indicates the first quantity comprises a quantity of monitored control candidates, a limit associated with a ratio of the quantity of monitored control candidates to the minimum scheduling offset, a limit associated with a ratio of the quantity of monitored control candidates to a control channel monitoring periodicity, a limit associated with a ratio of the quantity of monitored control candidates to the processing time, or any combination thereof.

Aspect 21: The method of aspect 13, wherein the first quantity is based at least in part on the processing time associated with an uplink grant, the minimum scheduling offset associated with the uplink grant, or both.

Aspect 22: The method of aspect 13, wherein the first quantity is based at least in part on the processing time associated with a downlink grant, the minimum scheduling offset associated with the downlink grant, or both.

Aspect 23: The method of aspect 13, wherein the first quantity is based at least in part on a downlink control information format.

Aspect 24: A UE for wireless communication, comprising one or more memories storing processor-executable code, and one or more processors coupled with the one or more memories and individually or collectively operable to execute the code to cause the UE to perform a method of any of aspects 1 through 12.

Aspect 25: A UE for wireless communication, comprising at least one means for performing a method of any of aspects 1 through 12.

Aspect 26: A non-transitory computer-readable medium storing code for wireless communication, the code comprising instructions executable by one or more processors to perform a method of any of aspects 1 through 12.

Aspect 27: A network entity for wireless communication, comprising one or more memories storing processor-executable code, and one or more processors coupled with the one or more memories and individually or collectively operable to execute the code to cause the network entity to perform a method of any of aspects 13 through 23.

Aspect 28: A network entity for wireless communication, comprising at least one means for performing a method of any of aspects 13 through 23.

Aspect 29: A non-transitory computer-readable medium storing code for wireless communication, the code comprising instructions executable by one or more processors to perform a method of any of aspects 13 through 23.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a network entity, first control signaling indicating a control channel search space configuration, wherein the control channel search space configuration comprises a plurality of monitored control candidates or control resources of a control channel; and
monitor a first subset of the plurality of monitored control candidates or control resources for a control channel message, wherein the first subset of the plurality of monitored control candidates or control resources comprises a first quantity of the plurality of monitored control candidates or control resources, and wherein the first quantity is based at least in part on a processing time associated with the UE, a minimum scheduling offset associated with the UE, or both.

2. The UE of claim 1, wherein the first quantity is based at least in part on a control channel monitoring periodicity.

3. The UE of claim 1, wherein the one or more processors are individually or collectively further operable to execute the code to cause the UE to:
monitor a second subset of the plurality of monitored control candidates or control resources, wherein the second subset of the plurality of monitored control candidates or control resources comprises a second quantity of the plurality of monitored control candidates or control resources that is based at least in part on a change in the processing time, a change in the minimum scheduling offset, a change in a control channel monitoring periodicity, or any combination thereof.

4. The UE of claim 3, wherein the second quantity is greater than or less than the first quantity.

5. The UE of claim 3, wherein, to monitor the second subset, the one or more processors are individually or collectively further operable to execute the code to cause the UE to:
select the second subset from a plurality of subsets of the plurality of monitored control candidates or control resources, wherein the control channel search space configuration comprises the plurality of subsets, and wherein each of the plurality of subsets comprise a different quantity of the plurality of monitored control candidates or control resources.

6. The UE of claim 3, wherein the one or more processors are individually or collectively further operable to execute the code to cause the UE to:
apply a hashing function to the plurality of monitored control candidates or control resources to identify the second subset of the plurality of monitored control candidates or control resources.

7. The UE of claim 1, wherein the one or more processors are individually or collectively further operable to execute the code to cause the UE to:
receive, from the network entity subsequent to monitoring the first subset of the plurality of monitored control candidates or control resources, second control signaling that indicates a second quantity of the plurality of monitored control candidates or control resources; and
monitor a second subset of the plurality of monitored control candidates or control resources, wherein the second subset of the plurality of monitored control candidates or control resources comprises a second quantity of the plurality of monitored control candidates or control resources.

8. The UE of claim 1, wherein the one or more processors are individually or collectively further operable to execute the code to cause the UE to:
transmit, to the network entity subsequent to receiving the first control signaling, second control signaling that indicates the first quantity.

9. The UE of claim 8, wherein the second control signaling that indicates the first quantity comprises a quantity of monitored control candidates, a limit associated with a ratio of the quantity of monitored control candidates to the minimum scheduling offset, a limit associated with a ratio of the quantity of monitored control candidates to a control channel monitoring periodicity, a limit associated with a ratio of the quantity of monitored control candidates to the processing time, or any combination thereof.

10. The UE of claim 1, wherein the first quantity is based at least in part on the processing time associated with an uplink grant, the minimum scheduling offset associated with the uplink grant, or both.

11. The UE of claim 1, wherein the first quantity is based at least in part on the processing time associated with a downlink grant, the minimum scheduling offset associated with the downlink grant, or both.

12. The UE of claim 1, wherein the first quantity is based at least in part on a downlink control information format.

13. A network entity, comprising:
one or more memories storing processor-executable code; and
one or more processors coupled with the one or more memories and individually or collectively operable to execute the code to cause the network entity to:
output, to a user equipment (UE), first control signaling indicating a control channel search space configuration, wherein the control channel search space configuration comprises a plurality of monitored control candidates or control resources of a control channel;
select a first monitored control candidate or control resource from a first subset of the plurality of monitored control candidates or control resources, wherein the first subset of the plurality of monitored control candidates or control resources comprises a first quantity of the plurality of monitored control candidates or control resources, and wherein the first quantity is based at least in part on a processing time associated with the UE, a minimum scheduling offset associated with the UE, or both; and
output, to the UE, one or more first control channel messages via the first monitored control candidate or control resource.

14. The network entity of claim 13, wherein the first quantity is based at least in part on a control channel monitoring periodicity.

15. The network entity of claim 13, wherein the one or more processors are individually or collectively further operable to execute the code to cause the network entity to:
output, to the UE, one or more second control channel messages via a second monitored control candidate or control resource selected from a second subset of the plurality of monitored control candidates or control resources, wherein the second subset of the plurality of monitored control candidates or control resources comprises a second quantity of the plurality of monitored control candidates or control resources that is based at least in part on a change in the processing time, a change in the minimum scheduling offset, a change in a control channel monitoring periodicity, or any combination thereof.

16. The network entity of claim 15, wherein the second quantity is greater than or less than the first quantity.

17. The network entity of claim 15, wherein the one or more processors are individually or collectively further operable to execute the code to cause the network entity to:
apply a hashing function to the plurality of monitored control candidates or control resources to identify the second subset of the plurality of monitored control candidates or control resources.

18. The network entity of claim 13, wherein the one or more processors are individually or collectively further operable to execute the code to cause the network entity to:
output, to the UE subsequent to the one or more first control channel messages, second control signaling that indicates a second quantity of the plurality of monitored control candidates or control resources; and
output, to the UE, one or more second control channel messages via a second monitored control candidate or control resource selected from a second subset of the plurality of monitored control candidates or control resources, wherein the second subset of the plurality of monitored control candidates or control resources comprises the second quantity of the plurality of monitored control candidates or control resources.

19. The network entity of claim 13, wherein the one or more processors are individually or collectively further operable to execute the code to cause the network entity to:
receive, from the UE subsequent to the first control signaling, second control signaling that indicates the first quantity.

20. The network entity of claim 19, wherein the second control signaling that indicates the first quantity comprises a quantity of monitored control candidates, a limit associated with a ratio of the quantity of monitored control candidates to the minimum scheduling offset, a limit associated with a ratio of the quantity of monitored control candidates to a control channel monitoring periodicity, a limit associated with a ratio of the quantity of monitored control candidates to the processing time, or any combination thereof.

21. The network entity of claim 13, wherein the first quantity is based at least in part on the processing time associated with an uplink grant, the minimum scheduling offset associated with the uplink grant, or both.

22. The network entity of claim 13, wherein the first quantity is based at least in part on the processing time associated with a downlink grant, the minimum scheduling offset associated with the downlink grant, or both.

23. The network entity of claim 13, wherein the first quantity is based at least in part on a downlink control information format.

24. A method for wireless communication by a user equipment (UE), comprising:
receiving, from a network entity, first control signaling indicating a control channel search space configuration, wherein the control channel search space configuration comprises a plurality of monitored control candidates or control resources of a control channel; and
monitoring a first subset of the plurality of monitored control candidates or control resources for a control channel message, wherein the first subset of the plurality of monitored control candidates or control resources comprises a first quantity of the plurality of monitored control candidates or control resources, and wherein the first quantity is based at least in part on a processing time associated with the UE, a minimum scheduling offset associated with the UE, or both.

25. The method of claim 24, wherein the first quantity is based at least in part on a control channel monitoring periodicity.

26. The method of claim 24, further comprising:
monitoring a second subset of the plurality of monitored control candidates or control resources, wherein the second subset of the plurality of monitored control candidates or control resources comprises a second quantity of the plurality of monitored control candidates or control resources that is based at least in part on a change in the processing time, a change in the minimum scheduling offset, a change in a control channel monitoring periodicity, or any combination thereof.

27. The method of claim 26, wherein monitoring the second subset further comprises:
selecting the second subset from a plurality of subsets of the plurality of monitored control candidates or control resources, wherein the control channel search space configuration comprises the plurality of subsets, and wherein each of the plurality of subsets comprise a different quantity of the plurality of monitored control candidates or control resources.

28. A method for wireless communication by a network entity, comprising:
outputting, to a user equipment (UE), first control signaling indicating a control channel search space configuration, wherein the control channel search space configuration comprises a plurality of monitored control candidates or control resources of a control channel;
selecting a first monitored control candidate or control resource from a first subset of the plurality of monitored control candidates or control resources, wherein the first subset of the plurality of monitored control candidates or control resources comprises a first quantity of the plurality of monitored control candidates or control resources, and wherein the first quantity is based at least in part on a processing time associated with the UE, a minimum scheduling offset associated with the UE, or both; and
outputting, to the UE, one or more first control channel messages via the first monitored control candidate or control resource.

29. The method of claim 28, wherein the first quantity is based at least in part on a control channel monitoring periodicity.

30. The method of claim 28, further comprising:
outputting, to the UE, one or more second control channel messages via a second monitored control candidate or control resource selected from a second subset of the plurality of monitored control candidates or control resources, wherein the second subset of the plurality of monitored control candidates or control resources comprises a second quantity of the plurality of monitored control candidates or control resources that is based at least in part on a change in the processing time, a change in the minimum scheduling offset, a change in a control channel monitoring periodicity, or any combination thereof.
